(19) United States
(12) Patent Application Publication
(10) Pub. No.: US 2011/0133647 A1
(43) Pub. Date: Jun. 9, 2011

(54) METHOD AND APPARATUS FOR PROVIDING HIGH BEAM IN LED HEADLAMP

(75) Inventors: Sung Uk Choi, Hwaseong-si (KR); Hun Soo Kim, Bucheon-si (KR); Hee Jun Jeong, Hwaseong-si (KR); Se Wook Oh, Gunpo-si (KR); Jong-Woon Kim, Gyeongsan-si (KR)

(73) Assignees: Hyundai Motor Company, Seoul (KR); SL Lighting Corporation, Daegu (KR)

(21) Appl. No.: 12/870,060

(22) Filed: Aug. 27, 2010

(30) Foreign Application Priority Data
Dec. 4, 2009 (KR) 10-2009-0120166

(51) Int. Cl. B60Q 1/04; F21V 21/14

(52) U.S. Cl. 315/82; 362/523

(57) ABSTRACT

A method for selectively providing a low beam state and a high beam state of an LED headlamp, may include driving an engine of a vehicle, switching on a multi-function switch to turn on at least a second LED module to emit a high beam after driving the engine to perform the high beam state of the LED headlamp, and converting a low beam state of at least a first LED module into a high beam state to perform the high beam state of the LED headlamp.

### CROSS-REFERENCE TO RELATED APPLICATION

The present application claims priority to Korean Patent Application Number 10-2009-120166, filed on Dec. 4, 2009, the entire contents of which are incorporated herein for all purposes by this reference.

### BACKGROUND OF THE INVENTION

1. Field of the Invention

The present invention relates to a method and an apparatus for providing a high beam in an LED headlamp, and more particularly to a method and an apparatus for providing a high beam in an LED headlamp, wherein, it is capable of converting a low beam state into a high beam (driving beam) state in order to strengthen the insufficient intensity of radiation of the high beam.

2. Description of Prior Art

In generally, a headlamp may be equipped to a vehicle in order to secure a visual field of the vehicle during the nighttime, and an LED (Light Emitting Diode) has been adopted as a light source (low beam and high beam) of the headlamp since the LED has been developed greatly in recent years.

FIG. 1 is a perspective view for illustrating an LED headlamp according to the prior art.

As shown in FIG. 1, the LED headlamp 10 according to the prior art may include the first LED module 11 for providing a low beam, and the second LED module 12 for providing a high beam.

On the other hand, a lot of LED modules are used to secure the intensity of radiation since the art of the LED headlamp 10 is not quite completed yet. That is, the number of the first LED module 11 is needed 4˜5 modules to embody the low beam, and the number of the second LED module 12 is needed at least two or more modules to embody the high beam.

But, because the LED headlamp 10 according to the prior art is purchased at a high price in comparison with a conventional halogen lamp, there was a problem that a prime cost may be increased due to a lot of LED modules. Furthermore, there was a problem that it is unfavorable to compose a package since the number of the second LED module 12 was needed at least two or more in order to secure the intensity of radiation of the high beam. Besides, there was a problem that the external appearance was not fine.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

In order to overcome the above-described problems, various aspects of the present invention are directed to provide a method for providing a high beam in an LED headlamp, wherein the method may decrease the number of LED module for providing a high beam by means of converting a low beam state into a high beam state by a driver's manipulation in order to strengthen the insufficient intensity of radiation of the high beam, and accordingly, it is possible to reduce a prime cost, secure a space for composing a package and design the external appearance of the LED headlamp beautifully.

In an aspect of the present invention, a method for selectively providing a low beam state and a high beam state of an LED headlamp, may include driving an engine of a vehicle, switching on a multi-function switch to turn on at least a second LED module to emit a high beam after driving the engine to perform the high beam state of the LED headlamp, and converting a low beam state of at least a first LED module into a high beam state to perform the high beam state of the LED headlamp.

A leveling device may be manipulated to convert the low beam state of the at least a first LED module into the high beam state thereof by adjusting a radiation angle of a low beam in the at least a first LED module to perform the high beam state of the LED headlamp, wherein the at least a first LED module is arranged at a side of the LED headlamp, and the at least a second LED module is arranged at another side of the LED headlamp.

The number of the at least a first LED modules may be larger than the number of the at least a second LED module, wherein, the number of the at least a first LED module is approximately between 2 and 8, and the number of the at least a second LED module is 1.

When the multi-function switch is switched to perform the low beam state of the at least a first LED module while the leveling device maintains toward an lower direction to provide the low beam, the high beam state of the at least a second LED module may be switched off and the leveling device for adjusting the radiation angle of the low beam in the at least a first LED module may not work.

When the multi-function switch is switched to perform the low beam state of the LED headlamp while the leveling device maintains toward an upper direction, the high beam state of the at least a second LED module may be switched off and the leveling device rotate toward a lower direction to provide the low beam.

In another aspect of the present invention, the apparatus for selectively providing a low beam state and a high beam state of an LED headlamp, may include an LED headlamp having a least a first LED module to emit a low beam, and at least a second LED modules to emit a high beam, a multi-function switch manipulating the at least a first LED module or the at least a second LED module to selectively convert the lower beam state and the high beam state of the LED headlamp, and a leveling device selectively adjusting a radiating angle of the low beam in the at least a first LED module toward the high beam of the at least a second LED module in accordance with the multi-function switch, wherein the leveling device converts the low beam state of the LED headlamp into a high beam state thereof when the multi-function switch is switched to the high beam state of the LED headlamp.

When the multi-function switch is switched to perform the low beam state of the LED headlamp while the leveling device maintains toward an lower direction to provide the low beam, the high beam state of the at least a second LED module may be switched off and the leveling device for adjusting the radiation angle of the at least a first LED module may not work.

When the multi-function switch is switched to perform the low beam state of the LED headlamp while the leveling device maintains toward an upper direction, the high beam state of the at least a second LED module may be switched off and the leveling device rotate toward a lower direction to provide the low beam.

According to the present invention, it may sufficiently secure the intensity of radiation of a high beam by converting a low beam state of the LED headlamp into a high beam state using a multi-function switch. And accordingly, it is possible to reduce a prime cost because of decreasing the number of high beams. Besides, it is possible to secure a space for composing a package, and design the external appearance of the LED headlamp beautifully.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view for illustrating an LED headlamp according to the prior art.

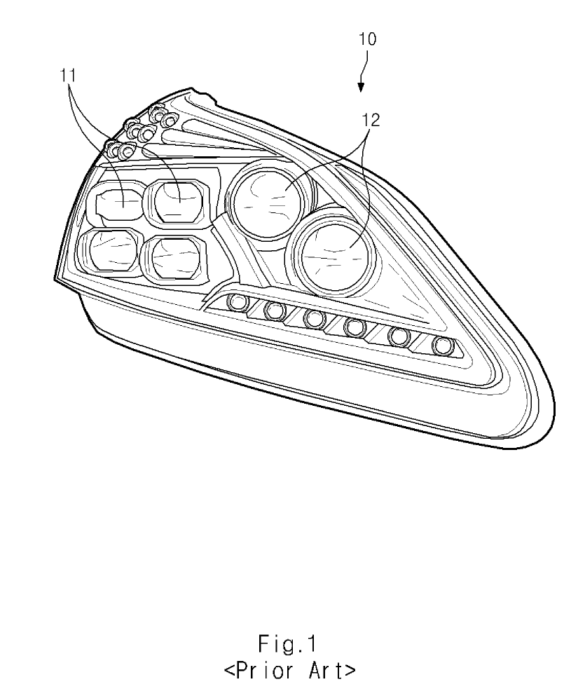

FIG. 2 is a view for illustrating an exemplary apparatus for providing a high beam in an LED headlamp according to the present invention.

FIG. 3 is a flowchart of an exemplary method for providing a high beam in an LED headlamp according to the present invention.

FIG. 4 is a view for illustrating a state of light distribution in an exemplary method for providing a high beam in an LED headlamp according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

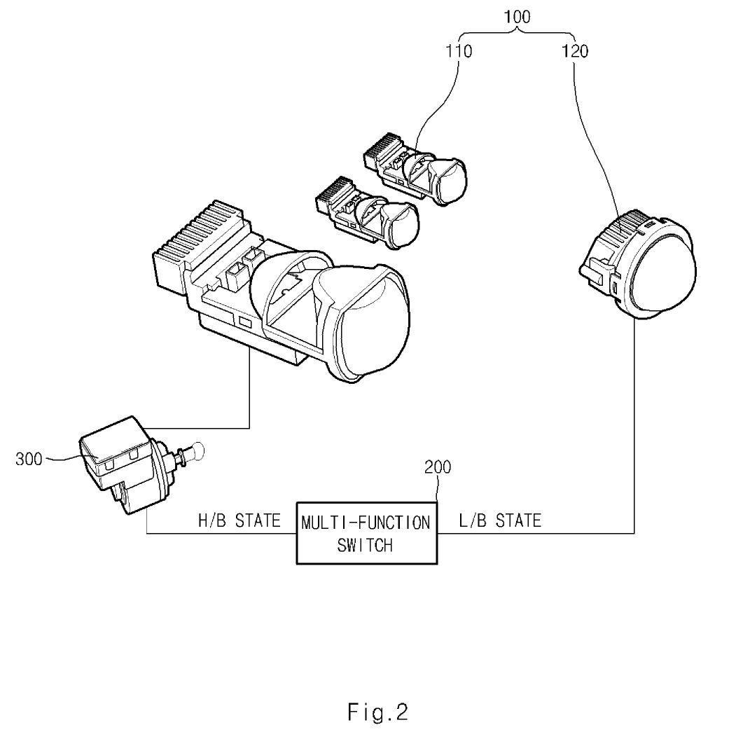

Now, a method for providing a high beam in an LED headlamp according to an exemplary embodiment of the present invention will be explained in detail with reference to the accompanying FIGS. 2 to 4.

According to the method for providing a high beam in an LED headlamp according to an exemplary embodiment of the present invention, it may increase the intensity of radiation of a high beam by converting a state of the first LED module 110 for providing a low beam of the LED headlamp 100 into a high beam (driving beam) state when a state of a multi-function switch 200 is switched to a high beam state, and accordingly, it may reduce the number of the second LED module 120 for providing the high beam. In addition, it may secure a space for composing a package, and it may allow the external appearance to be beautiful.

On the other hand, an apparatus for providing a high beam in an LED headlamp according to an exemplary embodiment of the present invention, as shown in FIG. 2, may include an LED headlamp 100 having a lot of first LED modules 110 for providing a low beam, and one or more second LED modules 120 for providing a high beam, a multi-function switch 200 for manipulating the first LED modules 110 and the second LED modules 120 so that they emit light, and a leveling device 300 for adjusting a radiating angle, wherein the leveling device 300 converts a low beam state of the first LED modules 110 for providing the low beam into the high beam state when the multi-function switch 200 is switched to the high beam state.

Here, since the LED headlamp 100 converts the low beam state of a lots of first LED module 110 for providing the low beam into the high beam state using the leveling device 300 for adjusting the radiating angle, it may sufficiently strengthen the intensity of radiation of the high beam, and accordingly, it may decrease the number of the second LED module 120 and it may minimize the number of the second LED module 120 into 1 module.

That is, the number of the first LED modules 110 may be 2˜8, and preferably, 4. In addition, the number of the second LED modules 120 may be one or more, and preferably, 1 module in order to easily compose a package.

The multi-function switch 200 is well known that it is connected to a steering column which is downward a steering wheel, wherein it may include a turn signal lever which operates a turn signal, a lamp or the like, and a wiper lever which operates a wiper, a washer liquid or the like.

That is, in case where the multi-function switch 200 is manipulated as a high beam state or the low beam state, an electric source is applied into the first LED module 110 or the second LED module 120 of the headlamp 100 in order to emit light.

The leveling device 300 for adjusting the radiating angle rotates one or more among a lot of first LED modules 110 for providing the low beam to be switched to a high beam state when a state of the multi-function switch 200 is switched to a high beam state. On the other hand, when a state of the multi-function switch 200 is switched to a low beam state, it may allow the first LED modules 110 to return to an original position or it may allow the first LED modules 110 not to work.

Now, a method for converting a low beam state into a high beam state using a system for providing a high beam in the LED headlamp having the above-described elements will be explained.

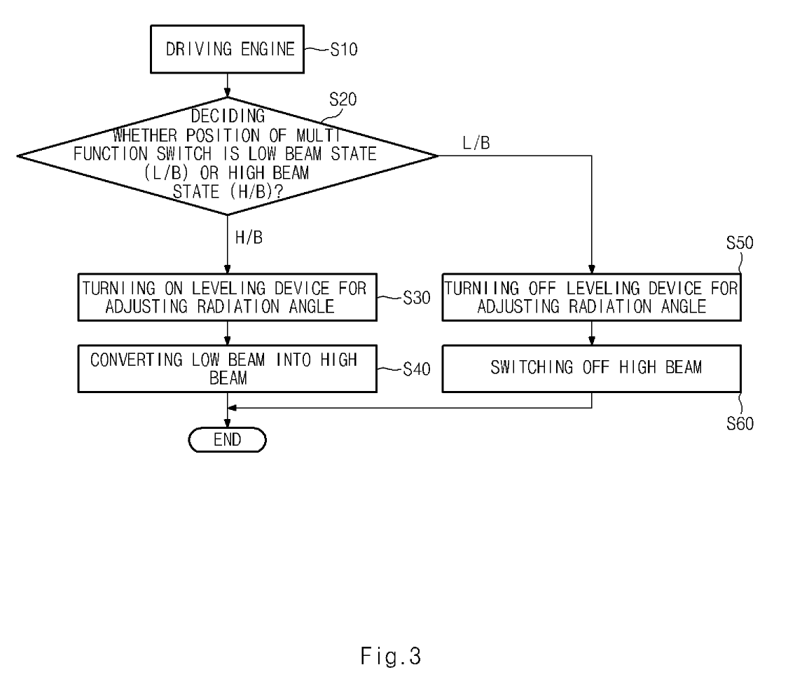

In the method for providing a high beam in the LED headlamp, as shown in FIG. 3, an engine of a vehicle is driven (S10).

In the above-described state, the driver may switch a state of the multi-function switch 200 to a high beam state or a low beam state (S20).

That is, in case where the state of the multi-function switch 200 is switched to the high beam state by the driver's manipulation, the leveling device 300 does work (S30). And then, one or more among a lot of first LED modules 110 for providing the low beam may be rotated upward direction in order to be switched to the high beam state by means of the operation of the leveling device 300 for adjusting the radiating angle (S40).

Therefore, since a low beam state of a lot of first LED modules 110 for providing a low beam is converted into a high beam state, the states of the first LED module 110 and the second LED module 120 become the high beam state in order to sufficiently secure the intensity of radiation.

On the other hand, in case where the state of the multi-function switch 200 is switched to the low beam state by the driver's manipulation, the leveling device 300 does not work (S50) if the leveling device 300 has been kept toward a lower direction, or the leveling device 300 may rotate toward a lower direction if the leveling device 300 has been kept toward an upper direction. Accordingly, the first LED module 110 maintains the low beam state, and, at the same time, the second LED module 120 for providing the high beam is switched off (S60).

Furthermore, when the state of the multi-function switch 200 is switched to the low beam state, it may notify an alarm toward the front of the vehicle by switching off the second LED module 120.

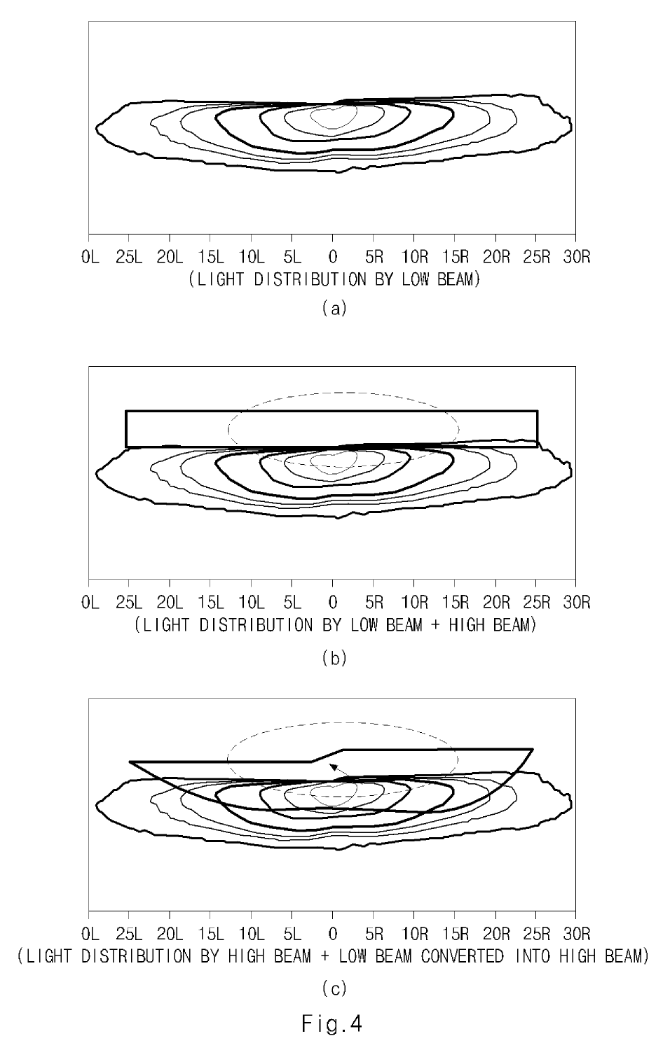

FIG. 4 is a view for illustrating a state of light distribution which is radiated toward the front of the vehicle by a method for providing a high beam in an LED headlamp according to an exemplary embodiment of the present invention.

That is, (a) of FIG. 4 illustrates a distribution state of light which is radiated from the first LED module 110 for providing a low beam, and (b) of FIG. 4 illustrates a distribution state of light which is radiated from each of the first LED module 110 for providing a low beam and the second LED module 120 for providing a high beam. In addition, (c) of FIG. 4 illustrates a distribution state of light which is radiated from the first LED module 110 for converting a low beam state into a high beam state by operating the leveling device 300 for adjusting the radiating angle according to an exemplary embodiment of the present invention and radiated from the second LED module 120 for providing a high beam at the same time.

Therefore, it may confirm that a light distribution shown in (c) of FIG. 4 is far increased in comparison with light distributions shown in (a) and (b) of FIG. 4.

For convenience in explanation and accurate definition in the appended claims, the terms “upper” and “lower” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for selectively providing a low beam state and a high beam state of an LED headlamp, comprising the steps of:
driving an engine of a vehicle;
switching on a multi-function switch to turn on at least a second LED module to emit a high beam after driving the engine to perform the high beam state of the LED headlamp; and
converting a low beam state of at least a first LED module into a high beam state to perform the high beam state of the LED headlamp.

2. The method according to claim 1, wherein a leveling device is manipulated to convert the low beam state of the at least a first LED module into the high beam state thereof by adjusting a radiation angle of a low beam in the at least a first LED module to perform the high beam state of the LED headlamp.

3. The method according to claim 2, wherein the at least a first LED module is arranged at a side of the LED headlamp, and the at least a second LED module is arranged at another side of the LED headlamp.

4. The method according to claim 1, wherein the number of the at least a first LED modules is larger than the number of the at least a second LED module.

5. The method according to claim 4, wherein, the number of the at least a first LED module is approximately between 2 and 8, and the number of the at least a second LED module is 1.

6. The method according to claim 2, wherein, when the multi-function switch is switched to perform the low beam state of the at least a first LED module while the leveling device maintains toward an lower direction to provide the low beam, the high beam state of the at least a second LED module is switched off and the leveling device for adjusting the radiation angle of the low beam in the at least a first LED module does not work.

7. The method according to claim 2, wherein when the multi-function switch is switched to perform the low beam state of the LED headlamp while the leveling device maintains toward an upper direction, the high beam state of the at least a second LED module is switched off and the leveling device rotate toward a lower direction to provide the low beam.

8. An apparatus for selectively providing a low beam state and a high beam state of an LED headlamp, comprising:
an LED headlamp having a least a first LED module to emit a low beam, and at least a second LED modules to emit a high beam;
a multi-function switch manipulating the at least a first LED module or the at least a second LED module to selectively convert the lower beam state and the high beam state of the LED headlamp; and
a leveling device selectively adjusting a radiating angle of the low beam in the at least a first LED module toward the high beam of the at least a second LED module in accordance with the multi-function switch,
wherein the leveling device converts the low beam state of the LED headlamp into a high beam state thereof when the multi-function switch is switched to the high beam state of the LED headlamp.

9. The apparatus according to claim 8, wherein, when the multi-function switch is switched to perform the low beam state of the LED headlamp while the leveling device maintains toward an lower direction to provide the low beam, the high beam state of the at least a second LED module is switched off and the leveling device for adjusting the radiation angle of the at least a first LED module does not work.

10. The apparatus according to claim 8, wherein when the multi-function switch is switched to perform the low beam state of the LED headlamp while the leveling device maintains toward an upper direction, the high beam state of the at least a second LED module is switched off and the leveling device rotate toward a lower direction to provide the low beam.

11. The apparatus according to claim 8, wherein the number of the at least a first LED modules is larger than the number of the at least a second LED module.
